(19) United States
(12) Patent Application Publication
(10) Pub. No.: US 2009/0232481 A1
(43) Pub. Date: Sep. 17, 2009

(54) SYSTEMS AND METHODS FOR HANDLING CONTENT PLAYBACK

(76) Inventors: Aaron Baalbergen, Miami, FL (US); Demian Martin, San Leandro, CA (US)

Correspondence Address: IPSG, P.C., P.O. BOX 700640, SAN JOSE, CA, 95170, US

(21) Appl. No.: 12/046,390

(22) Filed: Mar. 11, 2008

(51) Int. Cl. H04N 7/26

(52) U.S. Cl. 386/124

(57) ABSTRACT

A method for handling content to accommodate the movement of a user is disclosed. The method may include playing at least a first portion of the content using a first playback device. The method may also include storing status information concerning the playing the at least the first portion of the content. The method may also include receiving an identifier from a mobile device. The method may also include associating the status information with the identifier. The method may also include determining a start point of a second portion of the content using at least the identifier. The method may also include playing at least the second portion of the content using a second playback device.

### BACKGROUND OF THE INVENTION

The present invention relates to handling content, such as video, audio, image, and/or text content. In particular, the invention may involve playing content utilizing a first playback device in a first location and, for example, after a user of the content has moved from the first location to a second location, resuming playing the content utilizing a second playback device in the second location. In general, a playback device may represent an audio/video device and/or a communication device, such as a television, a radio, a media player, and/or a computer.

A playback device user may sometimes need to move from a first location, e.g., the living room in a house, to a second location, e.g., the kitchen in the house, when the user is consuming (e.g., watching or listening to) content. For example, the user may need to move from the living room to the kitchen when the user is watching a television program on a certain television channel, viewing a movie stored on a digital video disc (DVD), or listening to a song broadcasted by a certain radio station.

Conventionally, much inconvenience may be involved for the user to resume playing the content. For example, the user may need to memorize or note down the television channel, turn off the television in the living room, turn on the television in the kitchen, and enter the memorized or noted television channel to the television in the kitchen. As a result, a substantial delay or interruption may be introduced, and the user may miss a substantial portion of the television program. In addition, the user may also need to spend time adjusting the volume of the television in the kitchen to a comfortable level. As another example, the user may need to memorize or note down the time position indicated by the DVD player in the living room, eject the DVD from the DVD player in the living room, insert the DVD into the DVD player in the kitchen, and fast-forward the DVD to the memorized or noted time position. Such conventional processes may be substantially inconvenient and time-consuming.

### SUMMARY OF INVENTION

An embodiment of the present invention relates to a method for handling content to accommodate the movement of a user. The method may include playing at least a first portion of the content using a first playback device. The method may also include storing status information concerning the playing the at least the first portion of the content. The method may also include receiving an identifier from a mobile device. The method may also include associating the status information with the identifier. The method may also include determining a start point of a second portion of the content using at least the identifier. The method may also include playing at least the second portion of the content using a second playback device.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1A shows a schematic representation of a media/content playback system in accordance with one or more embodiments of the present invention.

FIG. 1B shows a schematic representation of the media/content playback system in the example of FIG. 1A in accordance with one or more embodiments of the present invention.

FIG. 2 shows a flowchart of a method for handling content playback in accordance with one or more embodiments of the present invention.

FIG. 3 shows a flowchart of a method for handling content playback in accordance with one or more embodiments of the present invention.

FIG. 4 shows a flowchart of a method for handling content playback in accordance with one or more embodiments of the present invention.

### DETAILED DESCRIPTION OF EMBODIMENTS

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

One or more embodiments of the present invention relate to a method for handling content to resume/continue playing the content after a user of the content has moved from a first location to a second location. In comparison with the conventional processes discussed above, the method may provide substantial convenience and may minimize the burden on the user; the method may also minimize the delay or interruption in the playback of the content.

The method may include playing at least a first portion of the content utilizing a first playback device, which is disposed in the first location, when the user is in the first location. The method may also include storing status information concerning playing the first portion of the content. For example, the status information may include information such as the content title, the chapter associated with the first portion, the time position of the end point of the first portion, the channel, the radio station, the audio device setting (e.g., the volume setting), and/or the video device setting (e.g., the brightness setting) related to playing the first portion of the content using the first playback device.

The status information may be stored in a central server and/or the first playback device. Alternatively or additionally, the status information may be stored in a mobile device carried by the user. For example, the mobile device may represent an infrared device (e.g., a remote control unit), a radio-frequency communication device (e.g., a mobile phone), and/or a radio-frequency identification (RFID) tag.

The method may also include transmitting an identifier from the mobile device to the first playback device, the central server, and/or a detection mechanism. The method may also include associating the status information with the identifier.

After the user has brought the mobile device to the second location. A second playback device, which is disposed in the second location, may directly or indirectly receive the identifier associated with the mobile device. Utilizing the identifier, the status information, and, in some embodiments, one or more user preference settings, the second playback device, the first playback device, and/or the central server may determine a start point of a second portion of the content for the user. Accordingly, the second playback device may resume playing the content from the start point of the second portion of the content. Advantageously, the method may enable content playback to be conveniently, efficiently, and accurately resumed/continued in the second location with minimum user interactions and efforts.

In one or more embodiments, the method may also involve detecting the presence of the mobile device carried by the user (and one or more other mobile devices carried by one or more other users) for properly handling the content playback.

One or more embodiments of the present invention may relate to a content/media playback system. The system may include components and arrangements for performing one or more steps in the method.

The features and advantages of the invention may be better understood with reference to the figures and discussions that follow.

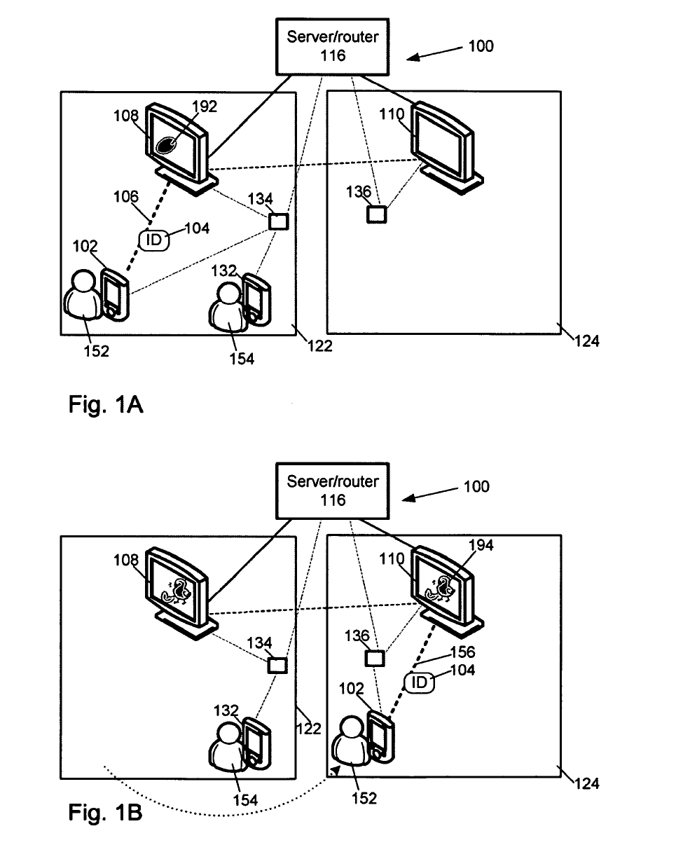

FIG. 1A shows a schematic representation of a media/content playback system 100 (hereinafter “system 100”) in accordance with one or more embodiments of the present invention. System 100 may include several playback devices, such as a playback device 108 and a playback device 110, disposed in different locations, such as a room 122 and a room 124. For example, a playback device may represent an audio/video device and/or a communication device, such as a television, a radio, a media player, and/or a computer. The playback devices may communicate with one another through a peer-to-peer arrangement. Alternatively or additionally, system 100 may include a server/router 116 (hereinafter “server 116”) coupled with the playback devices for facilitating communication among the playback devices. Server 116 may also provide data storage and/or data management for the playback devices.

System 100 may also include one or more mobile devices, such as a mobile 102 carried by a user 152 and a mobile device 132 carried by a user 154. For example, a mobile device in system 100 may represent an infrared device, a radio-frequency device, a mobile communication device, and/or a radio-frequency identification (RFID) tag.

System 100 may also include one or more detection mechanisms, such as a detection mechanism 134 associated with room 122 and a detection mechanism 136 associated with room 124, for detecting the mobile devices in system 100. The detection mechanisms may be implemented utilizing one or more well-known sensing technologies, such as Bluetooth® technology available from Bluetooth SIG, Inc. (www.bluetooth.com).

The example of FIG. 1A illustrates that users 152 and 154 are consuming (e.g., watching and/or listening to) a portion 192 of certain content utilizing playback device 108. System 100 may enable the content to be resumed in room 124 for user 152 in a convenient, efficient, and accurate manner after user 152 has moved from room 122 to room 124.

FIG. 1B also shows a schematic representation of system 100 in accordance with one or more embodiments of the present invention. As illustrated in the example of FIG. 1B, user 152 with mobile device 102 has moved from room 122 to room 124. Accordingly, system 100 has resumed/continued the playback of the content by playing a portion 194 of the content utilizing playback device 110 in room 124.

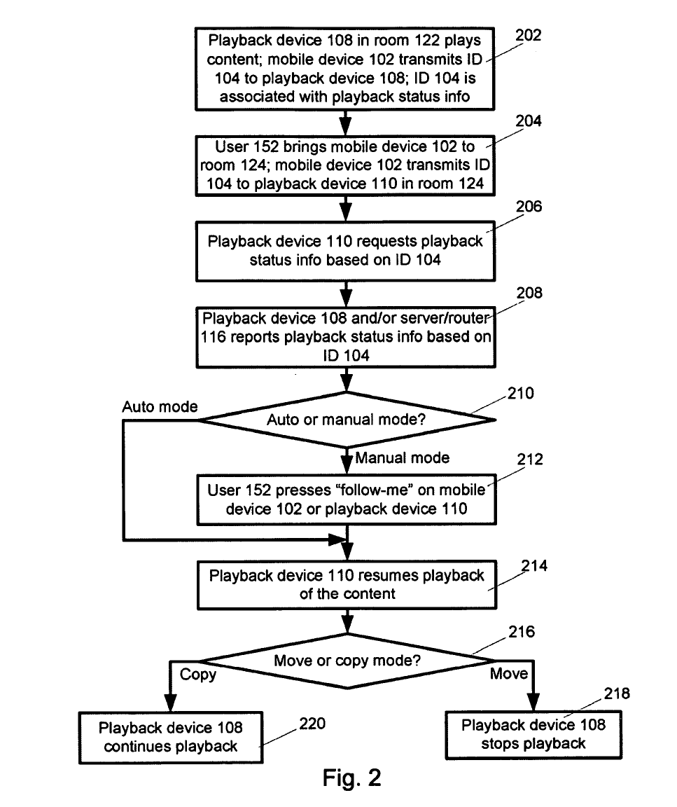

Example operations, features, and advantages of system 100 are further discussed with reference to the examples of FIGS. 2-4.

FIG. 2 shows a flowchart of a method for handling content playback in accordance with one or more embodiments of the present invention. The method may be implemented, for example, utilizing system 100 discussed in the example of FIG. 1. The method may start with step 202, in which playback device 108 in room 122 may play certain content (e.g. audio and/or video content) automatically or in response to a command provided by user 152 or 154. In step 202, mobile device 102 may transmit a unique identifier 104 (hereinafter “ID 104”) to playback device 108 and/or detection mechanism 134. As an example, ID 104 may be part of the infrared code transmitted by mobile device 102. As another example, ID 104 may be a unique serial number transmitted through one or more radio-frequency signals.

System 100 (e.g., server 116 and/or playback device 108) may record the playback status information concerning playback device 108's playing the content (or playing at least portion 192 of the content). For example, the playback status information may include information such as the title of the content, the channel or radio station that broadcasts the content, the time position of the content when mobile device 102 leaves the coverage of detection mechanism 134 or when user 152 requests a time stamp, the audio device setting (e.g., the volume setting), and/or the video device setting (e.g., the brightness setting) related to playback device 108's playing the content.

System 100 (e.g., server 116 and/or playback device 108) may also associate ID 104 with the playback status information. System 100 may also record the association. Given the association, system 100 may utilize ID 104 to determine a start point of portion 194 of the content for resuming the content for user 152.

For example, the playback status information associated with ID 104 may include the time position information that portion 192 of the content ends at “00:52:36” of the content, e.g., that a movie is interrupted at “00:52:36.” Accordingly, system 100 (e.g., playback device 110, playback device 108, and/or server 116) may set the start point of portion 194 of the content to be “00:52:36” of the content. In one or more embodiments, the start point of portion 194 may be a section or chapter marker in portion 192, such as the last section or chapter marker in portion 192, i.e., the section or chapter marker present immediately before “00:52:36” of the content. Accordingly, the continuity of the user's experience in consuming the content may be ensured. In one or more embodiments, system 100 may introduce a standard/default amount of an overlap between portions 192 and 194 of the content for improving the continuity of user experience in consuming the content. For example, if the default amount is 10 seconds, the start point of portion 194 of the content may be “00:52:26” of the content. In one or more embodiments, system 100 may allow user 152 to set the amount of the overlap. Advantageously, user 152 may customize and optimize the continuity according to the preferences of user 152.

System 100 may also record the environment information concerning playback device 108's playing the content in room 122. For example, the environment information may include information pertaining to the settings of lighting and temperature (or air conditioning) in room 122 when playback device 108 plays the content. System 100 may also associate the environment information with ID 104, such that a new environment associated with ID 104, i.e., a new environment in which mobile device 102 is disposed, may be automatically adjusted according to the settings in room 122.

Playback device 108 and/or detection mechanism 134 may also receive a second unique identifier from mobile device 132. System 100 may also associate the second unique identifier (which represents mobile device 132) with the playback status information and/or the environment information. System 100 may also record the association.

In step 204, user 152 may bring mobile device 102 to room 124. In room 124, mobile device 102 may transmit ID 104 directly or indirectly to playback device 110.

In step 206, playback device 10 may utilize ID 104 to request the playback status information that is associated with ID 104

In step 208, playback device 108 and/or server 116 may report the playback status information associated with ID 104 to playback device 110.

In step 210, system 100 (e.g., server 116 and/or playback device 110) may determine whether playback device 110 is configured to resume/continue playing the content according to an automatic mode or a manual mode. If the manual mode is default or has been previously selected, control may be transferred to step 212; if the automatic mode is default or has been previously selected, control may be transferred to step 214.

In step 212, user 152 may provide a command, for example, by pressing a “follow-me” button on mobile device 102 or playback device 110, to trigger playback device 110 to resume playing the content. In one or more embodiment, system 100 may ask user 152 whether the content is to be resumed, for example, through the user interface of mobile device 102, before receiving the command.

In step 214, playback device 110 may resume/continue the playback of the content. For example, playback device 110 may retrieve audio/video data from server 116 or receive data from the appropriate television channel to play portion 194 of the content from the start point discussed above. In step 214, system 100 or an associated automation system may also adjust one or more environment settings, such as lighting and temperature settings, in room 124 according to the environment information associated with ID 104 (or mobile device 102). According, one or more environment settings in room 122 may be automatically replicated in room 124.

In step 216, system 100 (e.g., server 116 and/or playback device 108) may determine whether system 100 is configured to resume/continue playing the content according to a “move” mode or a “copy” mode. If the “move” mode is default or has been previously selected, control may be transferred to step 218, in which playback device 108 may stop playing the content. If the “copy” mode is default or has been previously selected, control may be transferred to step 220, in which playback device 108 may continue playing the content, such that user 154 also may be able to continue watching and/or listening to the content.

As can be appreciated from the example for FIG. 2, with minimum efforts and minimum interruption, user 152 may continue to watch and/or listen to the content after having moved from room 122 to room 124. The environment settings in room 124 also may be automatically conformed to the settings in room 122 with minimum user interactions or operations.

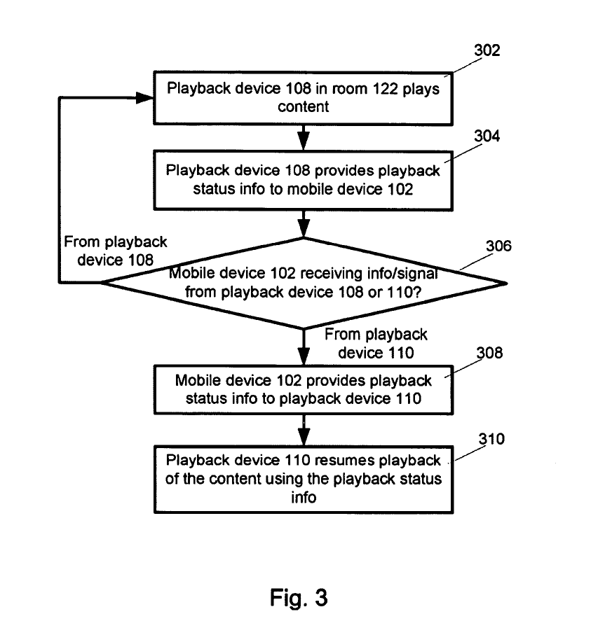

FIG. 3 shows a flowchart of a method for handling content playback in accordance with one or more embodiments of the present invention. The method may be implemented, for example, utilizing system 100 discussed in the example of FIG. 1. The method may start with step 302, in which playback device 108 in room 122 may play certain content automatically or in response to a command provided by user 152 or 154.

In step 304, playback device 108 may provide playback status information (e.g., similar to the playback status information discussed in step 202 in the example of FIG. 2) to mobile device 102. Accordingly, mobile device 102 may save the playback status information, for example, in a memory or storage device in mobile device 102. One or more components in system 100, such as detection mechanism 134, may provide environment information (e.g., similar to the environment information discussed in step 202 in the example of FIG. 2) mobile device 102. Mobile device 102 may also save the environment information.

In step 306, system 100 (e.g., server 116, playback device 108, playback device 110, detection mechanism 134, and/or detection mechanism 136) may determine whether mobile device 102 is receiving information from playback device 108 or is receiving one or more signals from playback device 110. If mobile device 102 is still receiving information from playback device 108, i.e., if user 152 and mobile device 102 are still in room 122, control may be transferred back to step 302, in which playback device 108 may continue to play the content. If mobile device 102 is receiving one or more signals from playback device 110, i.e., if user 152 and mobile device 102 have moved to room 124, control may be transferred to step 308.

In step 308, mobile device 102 may directly or indirectly provide the playback status information to playback device 110. Mobile device 102 may also provide the environment information to system 100 or an associated automation system, for example through playback device 110 and/or detection mechanism 136.

In step 310, playback device 110 may resume the playback of the content utilizing the playback status information provided by mobile device 102. System 100 or the associated automation system may also adjust one or more environment settings, such as lighting and temperature settings, in room 124 according to the environment information provided by mobile device 102.

As can be appreciated from the example for FIG. 3, the playback of the content may be conveniently, efficiently, and accurately resumed in various locations as long as user 152 simply brings mobile device 102 to the locations. In addition, a comfortable environment may be automatically replicated.

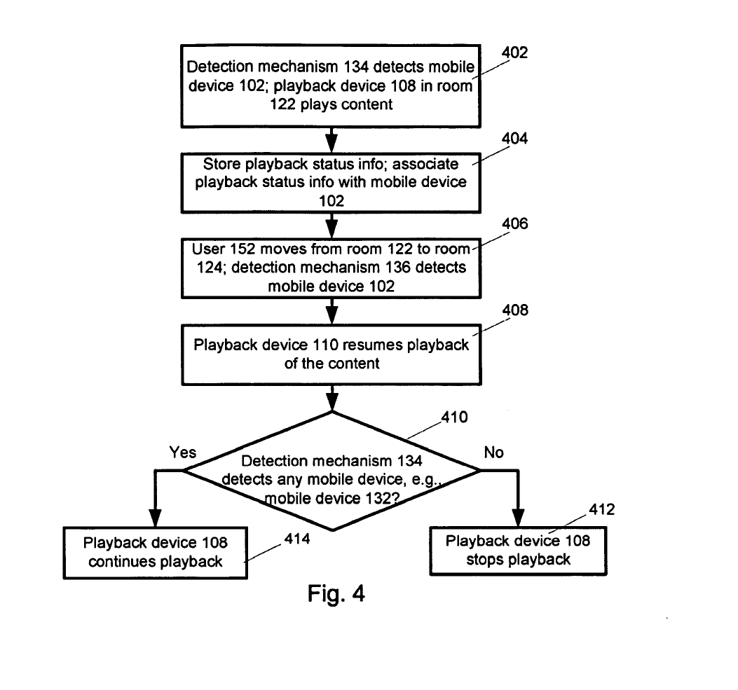

FIG. 4 shows a flowchart of a method for handling content playback in accordance with one or more embodiments of the present invention. The method may be implemented, for example, utilizing system 100 discussed in the example of FIG. 1. The method may start with step 402, in which detection mechanism 134 may detect mobile device 102 in room 122, for example, given that the strength of a signal transmitted from mobile device 102 to detection mechanism 134 is greater than a predetermined threshold. Accordingly, playback device 108 may continue to play content for user 152 to watch or listen to.

In step 404, system 100 (e.g., server 116, playback device 108, playback device 110, and/or mobile device 102) may store playback status information (e.g., similar to the playback status information discussed in step 202 in the example of FIG. 2). System 100 may also associate playback status information with mobile device 102. System 100 may also store environment information and may also associate the environment information with mobile device 102.

In step 406, user 152 may move from room 122 to room 124. Accordingly, detection mechanism 136 may detect mobile device 102.

In step 408, playback device 110 may resume playing the content utilizing the playback status information associated with mobile device 102. System 100 or an associated automation system may adjust environment settings in room 124 according to the environment information associated with mobile device 102.

In step 410, system 100 may determine whether there is still any user in room 122, for example, based on whether any mobile device (e.g., mobile device 132) is detected by mechanism 134. If there is not any user (represented by a mobile device) in room 122, control may be transferred to step 412, in which playback device 108 may stop playing the content. If there is still at least one user (represented by at least one mobile device) in room 122, control may be transferred to step 414, in which playback device 108 may continue playing the content.

As can be appreciated from the foregoing, when a user moves from one location to another location, embodiments of the invention may provide satisfactory continuity of content/media playback in a convenient, efficient, and accurate manner with minimum user efforts. For example, in contrast with conventional processes, embodiments of the invention may not require the user to memorize or note down information concerning the content and status of the playback of the content; embodiments of the invention may not require the user to eject, transport, and insert media, e.g., DVD; embodiments of the invention may not require the user to manually control fast-forwarding to find a start point to resume the playback. Embodiments of the invention may also automatically replicate comfortable environment settings in different locations. Advantageously, embodiments of the invention may optimize user mobility and user experience in consuming content.

While this invention has been described in terms of several embodiments, there are alterations, permutations, and equivalents, which fall within the scope of this invention. It should also be noted that there are many alternative ways of implementing the methods and apparatuses of the present invention. Furthermore, embodiments of the present invention may find utility in other applications. The abstract section is provided herein for convenience and, due to word count limitation, is accordingly written for reading convenience and should not be employed to limit the scope of the claims. It is therefore intended that the following appended claims be interpreted as including all such alterations, permutations, and equivalents as fall within the true spirit and scope of the present invention.

What is claimed is:

1. A method for handling content, the method comprising:
playing at least a first portion of the content using a first playback device;
storing status information concerning the playing the at least the first portion of the content;
receiving an identifier from a mobile device;
associating the status information with the identifier;
determining a start point of a second portion of the content using at least the identifier; and
playing at least the second portion of the content using a second playback device.

2. The method of claim 1 further comprising:
receiving a user command; and
performing the determining after the user command has been received.

3. The method of claim 1 wherein the second playback device automatically plays the second portion of the content without responding to a user command.

4. The method of claim 1 further comprising:
receiving user input regarding whether to copy content playback or to move the content playback;
if the content playback is set to be copied, continuing playing the content using the first playback device when the second portion of the content is played using the second playback device; and
if the content playback is set to be moved, stopping playing the content using the first playback device when the second portion of the content is played using the second playback device.

5. The method of claim 1 further comprising receiving user input for setting an amount of an overlap of the first portion of the content and the second portion of the content.

6. The method of claim 1 wherein the first portion of the content does not overlap the second portion of the content.

7. The method of claim 1 wherein the mobile device represents at least one of an infrared device, a radio-frequency device, a mobile communication device, and a radio-frequency identification tag.

8. The method of claim 1 wherein the identifier is a unique serial number of the mobile device.

9. The method of claim 1 wherein the first playback device and the second playback device are disposed in different rooms in a same building.

10. The method of claim 1 wherein the status information includes at least one of content title information, time position information, channel information, radio station information, audio device setting information, and video device setting information.

11. The method of claim 1 wherein the start point represents the last chapter marker in the first portion of the content.

12. A method for handling content, the method comprising:
playing at least a first portion of the content using a first playback device;
storing in a mobile device status information concerning the playing the at least the first portion of the content;
transmitting the status information from the mobile device to a second playback device; and
playing at least a second portion of the content using the second playback device and using the status information.

13. The method of claim 12 further comprising receiving a user command for the playing the at least the second portion of the content, wherein the user command triggers the transmitting.

14. The method of claim 12 further comprising:
detecting the mobile device using a detection mechanism, the detection mechanism associated with the second playback device;
requesting the transmitting if the mobile device is detected,
wherein the playing at least the second portion of the content using the second playback device is performed automatically without involving a user command.

15. The method of claim 12 further comprising:
if content playback is set to be copied, continuing playing the content using the first playback device when the second portion of the content is played using the second playback device; and
if the content playback is set to be moved, stopping playing the content using the first playback device when the second portion of the content is played using the second playback device.

16. The method of claim 12 further comprising receiving user input for setting an amount of an overlap of the first portion of the content and the second portion of the content.

17. A method for handling content, the method comprising:
associating a first detection mechanism with a first playback device;
associating a second detection mechanism with a second playback device;
using the first detection mechanism to detect a mobile device;
playing at least a first portion of the content using the first playback device;
storing status information concerning the playing the at least the first portion of the content; and
associating the status information with the mobile device; and
if the second detection mechanism detects the mobile device, playing at least a second portion of the content using the second playback device using the status information.

18. The method of claim 17 further comprising:
storing the status information in the first playback device; and
transmitting the status information from the first playback device to the second playback device after the second detection mechanism has detected the mobile device.

19. The method of claim 17 further comprising:
coupling the first playback device with a server;
coupling the second playback device with the server;
storing the status information in the server; and
transmitting the status information from the server to the second playback device after the second detection mechanism has detected the mobile device.

20. The method of claim 17 further comprising:
if the second detection mechanism detects a second mobile device, continuing playing the content using the first playback device when the second portion of the content is played using the second playback device; and
if the second detection mechanism does not detect the second mobile device, stopping playing the content using the first playback device when the second portion of the content is played using the second playback device.

21. The method of claim 17 further comprising:
storing environment information concerning the playing the at least the first portion of the content;
using the environment information to adjust one or more environment settings when playing the at least the second portion of the content using the second playback device,
wherein the environment information includes at least one of lighting information and temperature information, and
the one or more environment settings include at least one of a lighting setting and a temperature setting.
